(19) United States
(12) Patent Application Publication
(10) Pub. No.: US 2006/0278030 A1
(43) Pub. Date: Dec. 14, 2006

(54) Steering column vibration isolators and method of adjustment thereto

(76) Inventors: Josh M. Tavel, Grosse Pointe Woods, MI (US); Frederick P. Hohnstadt, Clarkston, MI (US); Michael T. Trahan, Grand Blanc, MI (US); Sharon K. Martin, Troy, MI (US); Jason E. Miller, Brighton, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/148,153

(22) Filed: Jun. 8, 2005

(51) Int. Cl. B62D 1/16

(52) U.S. Cl. 74/492

(57) ABSTRACT

Vibration isolators for a steering column which are optimized to adjust the resonance frequency of the steering column so that it is not at the same frequency as the engine firing pulses of a DoD engine operating in the full economy mode window, nor at road travel vibration frequencies. The vibration isolators are composed of a resilient grommet and a rigid insert, and are located at each mounting bracket of the steering column. Adjustment of grommet durometer, grommet dimensions and grommet width relative to insert length provide a selective compression and resiliency of the grommet which selectively adjusts the resonance frequency of the steering column below the range of frequencies of the engine when operating in economy mode.

### TECHNICAL FIELD

The present invention relates to automotive steering columns, and more particularly to steering column vibration isolators. Still more particularly, the present invention relates to a method for optimizing steering column vibration isolators to adjust (i.e., tune) the steering column resonance frequency to a frequency that is lower than a range of vibration frequencies produced by an internal combustion engine, particularly a “displacement on demand” (DoD) engine, operating in a selected mode of operation, particularly the economy mode of the DoD engine, and higher than a range of vibration frequencies caused by road travel.

### BACKGROUND OF THE INVENTION

The steering column provides a housing for rotatably supporting a steering shaft and its associated steering wheel. In that the steering wheel is hand-held by the driver and is ultimately connected to the frame of the vehicle, vibration from an operating engine is mechanically conducted to the steering wheel, and ultimately to the hands of the driver.

A steering column with its associated steering shaft and steering wheel can be regarded as a vibrationally driven harmonic oscillator, wherein the engine vibration causes the vibrational driving. When the vibration frequency of the engine approaches the same frequency as the resonance (i.e., natural) vibration frequency of a steering column, then resonance of the steering column will occur. When resonance occurs, noticeable and objectionable shake of the steering wheel is experienced by the driver.

In the prior art, the steering column is provided with a plurality (typically four) mounting flanges which provide attachment of the steering column to an instrument panel (IP) bracket which is, itself connected to the vehicle frame. The steering column is rigidly attached to the IP bracket via a threaded fastener at each mounting flange. In order to change the resonance frequency of the steering column in the prior art, typically mass is added, either by being rigidly mounted thereto or by being mounted thereto on rubber (referred to as a tuned absorber) wherein the mass inherently changes the resonance frequency of the steering column.

An internal combustion engine of interest with respect to steering column resonance frequency is a “displacement on demand” (DoD) engine, in that it produces a specific range of vibration frequencies specific to each respective mode of operation of the engine. For example, a DoD eight cylinder engine operates in “normal mode” on all eight cylinders, whereas this same engine operates on four cylinders when in “economy mode”. The frequency of vibration of an engine is related to the number of firing cylinders. When in the normal mode, the frequency of engine vibration (typically above 60 Hz) is sufficiently high that steering column resonance is not a concern. However, when operating in economy mode, the frequency of engine vibration (now, typically above 30 Hz) overlaps the resonance frequency (generally between 33 Hz and 39 Hz, most typically around 37 Hz) of a steering column that has been mounted according to the prior art for an eight cylinder engine.

Problematically, when a DoD engine runs in economy mode (i.e., on four cylinders), the engine firing pulses vibrationally excite the steering column around its 37 Hz resonance frequency. Therefore, in order to ensure economy mode operation does not resonantly excite the steering column, economy mode operation must be restricted so that engine vibration is above the 37 Hz resonance frequency of the steering column. This has the consequence that economy mode must switch to normal mode (i.e., eight cylinders) at or below about 1,200 revolutions per minute (RPM). This restriction in the engine speed range of the DoD engine results in a limited operating window of the economy mode, with the consequence that a limited amount of fuel economy improvement is achieved by a DoD engine as compared to a conventional eight cylinder engine. Indeed, the fuel economy improvement is only about 6%, yet if the DoD could be operated in an unrestricted engine speed window of operation, a 9% fuel improvement could be expected.

An aspect of further consideration is road travel vibration as a motor vehicle is driven. Typically, road travel vibration is in the range of frequencies below about 26 Hz. If a steering column has a resonance frequency at or below 26 Hz, then the steering wheel will noticeably and undesireably shake every time road travel frequencies match the resonance frequency of the steering column. This is avoided in the prior art because the steering column is rigidly mounted to the IP bracket, whereby the resonance frequency (i.e., 37 Hz) of the steering column is inherently well above the road travel frequencies (i.e., below 26 Hz). Thus, in the prior art it has been the practice to keep the steering column resonance frequency as high as possible to avoid overlap with road travel frequencies.

Accordingly, what remains needed in the prior art is to somehow isolate the steering column from engine vibration and, in so doing, adjust (tune) the resonance (i.e., natural) frequency of the steering column so that it is not at the same frequency as the vibration caused by the engine firing pulses of a DoD engine operating in the full economy mode engine speed window, nor at road travel vibration frequencies.

### SUMMARY OF THE INVENTION

The present invention provides vibration isolators for a steering column which are optimized to adjust (tune) the resonance (i.e., natural) frequency of the steering column so that it is not at the same frequency of vibration generated by the engine firing pulses of a DoD engine operating in the full economy mode engine speed window, nor at road travel vibration frequencies.

The vibration isolators according to the present invention are disposed at each of the mounting flanges of the steering column, whereby vibration of the engine passing through the IP bracket to the steering column is decoupled such that the resonance frequency of the steering column is adjusted to fall outside the range of frequencies associated with road travel and engine vibrations.

Each vibration isolator includes a resilient elastomeric grommet and a rigid, preferably metallic, insert. The grommet is preferably composed of a rubber having a predetermined durometer. The grommet is in the form of a pair of washer-like stems separated by a neck, wherein the outer diameter of the stems is much larger than the outer diameter of the neck. A central hole passes through the grommet. The insert is in the form of a sleeve with a washer at one end of the sleeve, wherein the outside diameter of the washer is much lager than the outside diameter of the sleeve. An attachment hole passes through the insert. The insert is required in order to maintain rigid joint characteristics at the connection between the mounting brackets and the IP bracket, and does not exhibit creep over time. Cooperatively, the outside diameter of the sleeve is such that it slides snugly into the central hole of the grommet.

The vibration isolators each have a geometry appropriate to the respective mounting brackets. For example, the forward mounting brackets have circular mounting holes, whereas the rearward mounting brackets have elliptical mounting holes which allow for tolerances. Accordingly, the vibration isolators intended for the forward mounting brackets (i.e., forward vibration isolators) are circularly configured, whereas vibration isolators intended for the rearward mounting brackets (i.e., rearward vibration isolators) are elliptically configured.

In operation, a grommet is placed into each mounting hole of each mounting bracket, wherein the stems amply overlap the mounting holes, and wherein the necks fill the mounting holes. Next the sleeve of an insert is respectively placed into each central hole, whereupon the washer abuts a stem. Lastly, the steering column is located so that an IP bracket mounted stud respectively slides into each attachment hole of the sleeves, wherein a steel washer is installed which abuts the stem opposite the washer component of the insert, and a nut is threadingly tightened onto the stud to thereby secure the steering column to the IP bracket. Now, vibrations of the engine and road travel travelling through the IP bracket are decoupled with respect to vibrations of the steering column at the vibration isolators.

According to the present invention, the joint stiffness of the vibration isolators is optimized to adjust (tune) the resonance frequency of the steering column to a vibration frequency below frequencies generated by a DoD engine operating in a selected engine speed window of its economy mode and above road travel frequencies.

According to the method of the present invention, each vibration isolator is optimized by iterative adjustment of one or more of its physical parameters followed by testing to ascertain the resonance frequency of the steering column in relation to the known vibration frequencies of the engine and road travel. In this regard, the grommet is optimized by adjustment to its composition, dimensions and durometer (i.e., hardness/resiliency), and the insert is optimized by adjustment to its dimensions, wherein the combined optimizations include the sleeve length to grommet width resulting in a selected compression of the grommet when in operation. The iterations may be performed by physical, mathematical or computer modeling, wherein a number of iterations can be performed. Indeed, with sufficient fortuity or knowledge, only a single iteration may be required to provide the optimization of the vibration isolators.

It is seen, therefore, that the vibration isolators according to the present invention provide a selected amount of decoupling which allows for the DoD engine to operate in economy mode with a full engine speed window of operation such that the resonance frequency of the steering column is below the vibration frequencies of the engine in economy mode and above the vibration frequencies of road travel vibrations.

Accordingly, it is an object of the present invention to provide vibration isolation of a steering column which adjusts (tunes) the joint stiffness so that the resonance frequency of the steering column is below that of vibration frequencies generated by a DoD engine operating in a full engine speed window of economy mode, and simultaneously above road travel vibration frequencies.

This and additional objects, features and advantages of the present invention will become clearer from the following specification of a preferred embodiment.

### BRIEF DESCRIPTION OF THE DRAWINGS

FIG. 1 is a partly sectional, perspective view of a steering column having mounted thereto vibration isolators according to the present invention.

FIG. 2 is a detail, partly sectional view of a vibration isolator, seen along arrow 2 of FIG. 1.

FIG. 3A is an exploded view of an elliptical geometry vibration isolator (rearward vibration isolator) according to the present invention.

FIG. 3B is a sectional view of the elliptical geometry vibration isolator (rearward vibration isolator) according to the present invention, shown received by an elliptical rearward mounting hole of a mounting bracket of a steering column.

FIG. 4A is an exploded view of a circular geometry vibration isolator (forward vibration isolator) according to the present invention.

FIG. 4B is a sectional view of the circular geometry vibration isolator (forward vibration isolator) according to the present invention shown received by a circular forward mounting hole of a mounting bracket of a steering column.

FIG. 5 is a side view of a steering column attached to an IP bracket utilizing vibration isolators according to the present invention.

FIG. 6 is a side view of the circular geometry vibration isolator (forward vibration isolator) of FIG. 4B, shown in operation with respect to the mounting of a steering column to an IP bracket.

FIG. 6A is a sectional view as in FIG. 4B showing the vibration isolator now under compression during operation as shown at FIG. 6.

FIG. 7 is a sectional view of a circular geometry vibration isolator (forward vibration isolator) according to the present invention shown received by a circular forward mounting hole of a mounting bracket of a steering column, wherein the sleeve is shorter relative to the grommet width as compared to the sleeve length and grommet width shown at FIG. 4B.

FIG. 8 is a side view of the circular geometry vibration isolator (forward vibration isolator) of FIG. 7, shown in operation with respect to the mounting of a steering column to an IP bracket.

FIG. 8A is a sectional view as in FIG. 7 showing the vibration isolator now under compression during operation as shown at FIG. 8.

FIG. 9 is a graph of various steering column vibrational frequencies versus engine RPM for a DoD engine operating in economy mode.

### DESCRIPTION OF THE PREFERRED EMBODIMENT

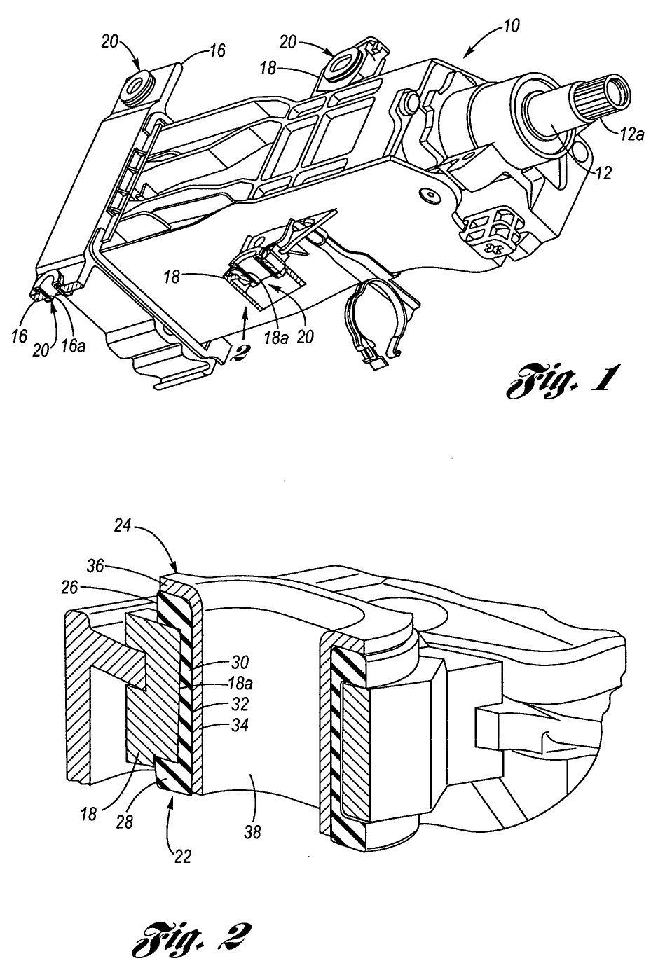

Referring now to the drawing, FIG. 1 depicts a steering column 10 having a steering shaft 12 to which a steering wheel (not shown) is attached at the shaft end 12a. The steering column 10 has a pair of forward mounting brackets 16 and a pair of rearward mounting brackets 18, wherein the forward mounting brackets have circular mounting holes 16a and the rearward mounting brackets have elliptical mounting holes 18a. Located at each of the mounting brackets 16, 18 is a vibration isolator 20 according to the present invention.

As shown additionally at FIG. 2, each vibration isolator 20 includes a grommet 22 and an insert 24 received by the grommet. Each grommet 22 is composed of a resilient elastomeric material, preferably a rubber of a selected durometer. Each insert 24 is rigid and preferably composed of a metal, as for example steel treated to resist corrosion. The grommet 22 is in the form of a pair of (washer-like) stems, a first stem 26 and a second stem 28 separated by a neck 30, wherein the outer diameter of the stems is much larger than the outer diameter of the neck. The grommet 24 has a central hole 32. The insert 24 is in the form of a sleeve 34 with an integrally connected washer 36 at one end of the sleeve, wherein the outside diameter of the washer is much lager than the outside diameter of the sleeve. The insert has an attachment hole 38. Cooperatively, the outside diameter of the sleeve 34 is such that it slides snugly into the central hole 32 of the grommet 22. There are two geometries of the vibration isolators 20 for providing geometrical correspondence to the two geometries of mounting holes: an elliptical geometry vibration isolator for being received by the elliptical mounting holes 18a, and a circular geometry vibration isolator for being received by the circular mounting holes 16a.

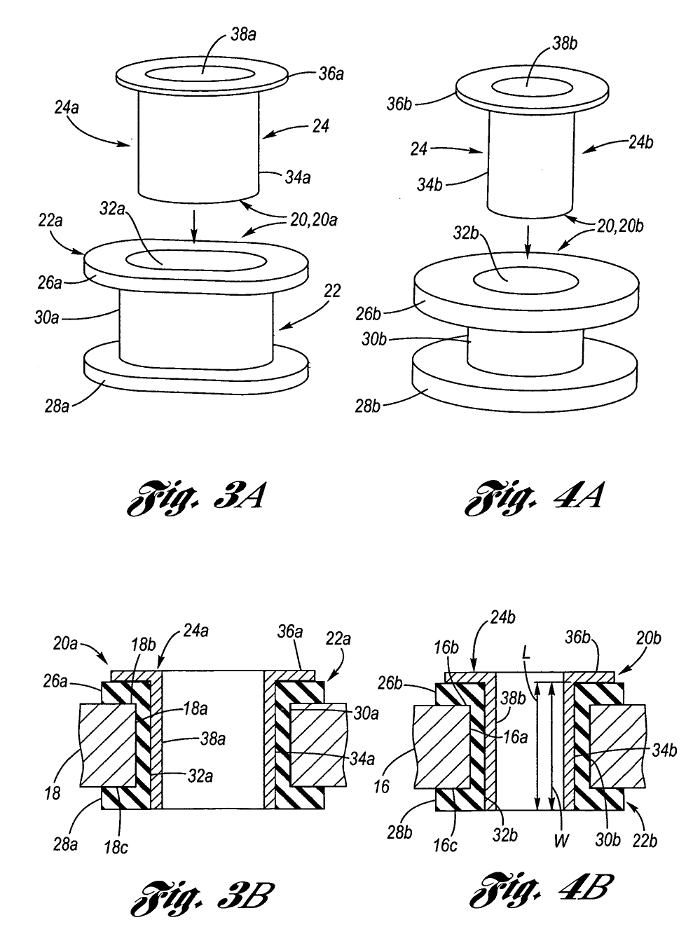

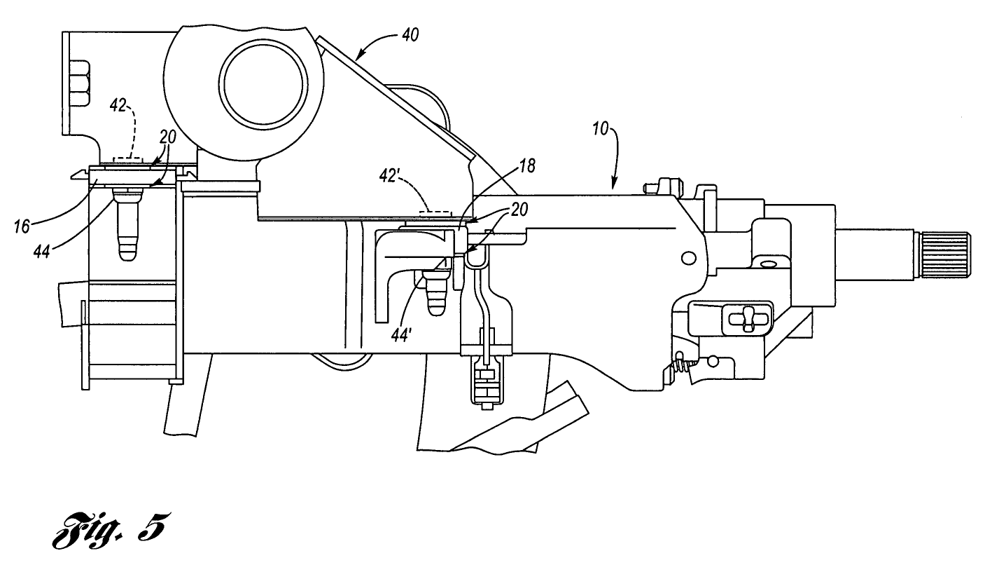

Referring now additionally to FIGS. 3A through 4B the structure of the vibration isolators 20 will be further detailed.

Referring firstly to FIGS. 3A and 3B, the elliptical geometry vibration isolator 20a is depicted, which is also referred to herein as the “rearward” vibration isolator because it is placed at the rearward mounting bracket 18 (its constituents being also designated as “rearward” constituents). The grommet 22a is as above described, wherein now the geometry of the first and second stems 26a, 28a, of the neck 30a and of the central hole 32a are all elliptical. Additionally, the insert 24a is as above described, wherein now the geometry of the sleeve 26a, of the washer 36a, and of the attachment hole 38a are also elliptical. The outside diameter of the neck 30a is such that the neck snugly abuts the elliptically shaped mounting hole 18a, wherein the first and second stems 26a, 28a amply overlap the mounting hole so as to abut the opposed surfaces 18b, 18c of the mounting bracket 18. The sleeve 34a is snugly received in the central hole 32a of the grommet 22a, and the washer 36a is shown abutting the first stem 26a.

Referring next to FIGS. 4A and 4B, the circular geometry vibration isolator 20b is depicted which is also be referred to herein as the “forward” vibration isolator because it is placed at the forward mounting bracket 16 (its constituents also being designated as “forward” constituents). The grommet 22b is as above described, wherein now the geometry of the first and second stems 26b, 28b, of the neck 30b and of the central hole 32b are all circular. Additionally, the insert 24b is as above described, wherein now the geometry of the sleeve 34b, of the washer 36b, and the attachment hole 38b are also circular. The outside diameter of the neck 30b is such that the neck snugly abuts the circularly shaped mounting hole 16a, wherein the first and second stems 26b, 28b amply overlap the mounting hole so as to abut the opposed surfaces 16b, 16c of the mounting bracket 16. The sleeve 34b is snugly received in the central hole 32b of the grommet 22b, and the washer 36b is shown abutting the first stem 26b.

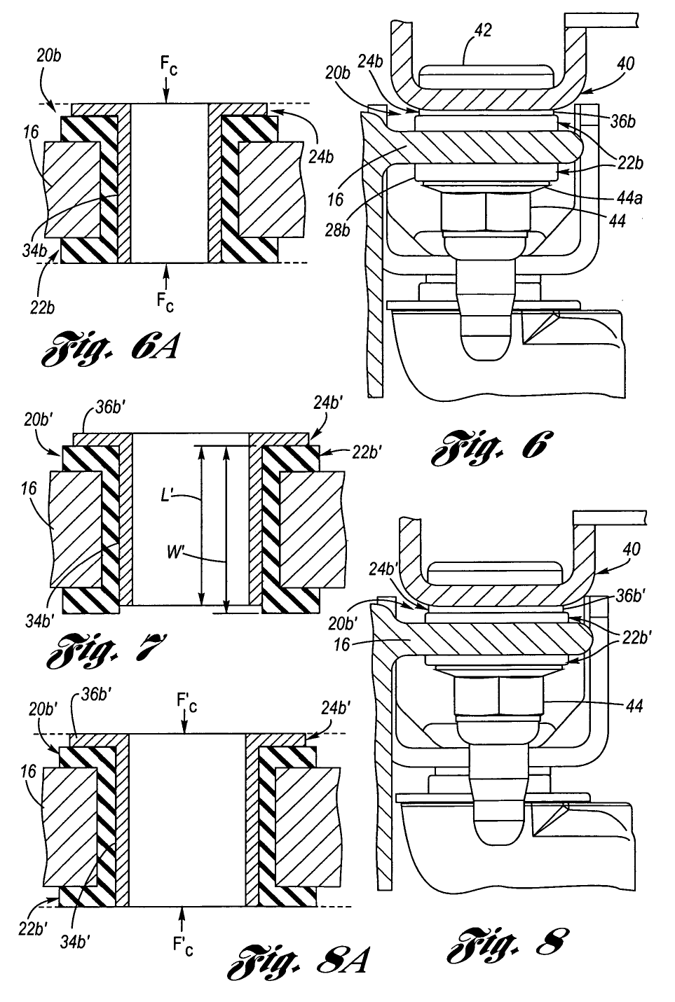

Referring now additionally to FIGS. 5 through 9, operational aspects of the vibration isolators 20 according to the present invention will be detailed.

The mounting holes of the mounting brackets 16, 18, more particularly the attachment holes 38a, 38b of the sleeves 34a, 34b thereat (see FIGS. 3B and 4B), are aligned with studs 42, 42′ which are mounted to the IP bracket 40. Each of the studs respectively slides into an attachment hole 38a, 38b of the sleeves 24a, 24b, wherein a steel washer (see 44a in FIG. 6) is installed which abuts the stem 28a, 28b opposite the respective insert washer 36a, 36b, and a nut 44, 44′ is threadingly tightened onto the stud to thereby secure the steering column 10 to the IP bracket (see generally FIG. 5). Now, vibration travelling through the IP bracket 40 is decoupled from vibration of the steering column by the vibration isolators 20 so as to adjust (tune) the resonance frequency of the steering column 10 according to the method of the present invention.

According to the method of the present invention, the vibration decoupling of the vibration isolators is optimized to adjust (tune) the resonance frequency of the steering column to a frequency below vibration frequencies generated by a DoD engine operating in a selected engine speed window of its economy mode and above vibration frequencies generated by road travel.

Each of the vibration isolators 20 has one or more of its physical parameters optimized to achieve the aforementioned adjustment to the resonance frequency below engine vibration frequencies (particularly for the DoD engine speed window of economy mode) and above road travel vibration frequencies. In this regard, physical parameters of the grommets 22 are optimized by adjustment to their composition, dimensions (as for example thicknesses) and durometer (i.e., hardness/resiliency). In this regard further, physical parameters of the inserts 24 are optimized by adjustment to their dimensions (as for example sleeve length). The adjustment to the physical parameters of the vibration isolators includes adjustment by synergistic physical parameter optimization (as for example the sleeve length in relation to the width of the grommet).

Comparison of FIGS. 4B, 6 and 6A to FIGS. 7, 8 and 8A provides an exemplification of physical parameter optimization of the vibration isolators 20 based upon synergy of physical parameter optimization of the grommet 22 and the insert 24.

In FIG. 4B, the length L of the sleeve 34b of the insert 24b is about the same as the width W of the grommet 22b. Accordingly, when placed into operational service with respect to a forward mounting bracket 16 and an IP bracket 40, as shown at FIGS. 6 and 6A, the grommet 22b has a low level of compression by the grommet resiliently compressing to a new width equal to the length of the sleeve 34b by application thereto of a compressive force F_{c}, whereupon a first level of decoupling and a first resonance frequency of the steering column are provided.

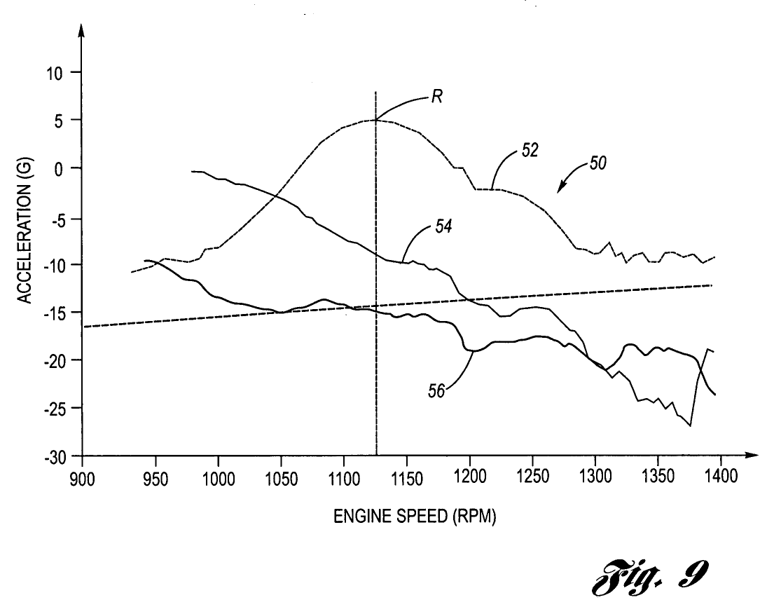

In FIG. 7, the length L′ of the sleeve 34b ′ of the insert 24b′ is clearly less than the width W′ of the grommet 22b′. Accordingly, as shown now at FIGS. 8 and 8A, when placed into operational service with respect to the forward mounting bracket 16 and the IP bracket 40 (the same as at FIG. 6), the grommet 22b ′ has a high level of compression caused by the grommet resiliently compressing to a new width equal to the length of the sleeve 34b ′ by application thereto of a compressive for F_{c}′, whereupon a second level of decoupling and a second resonance frequency of the steering column are provided.

It will be seen from the foregoing examples that the compression of the grommet 22b, 22b ′ depends upon the physical parameters of the vibration isolators 20b, 20b′, including the dimensions of the inserts 24b, 24b′, composition, dimensions and durometer of the grommets 22b, 22b′, so that there is compression of the grommets when a respective compressive force F_{c}, F_{c}′ is applied to the vibration isolators such that each grommet is compressed to a second width equal to the length of its respective sleeve.

By iteratively adjusting, as for example by physical, mathematical or computer modeling, the various physical parameters of the grommets and the sleeves, followed by testing each adjustment, optimized vibration isolators 20 are resultantly achieved, wherein it is to be understood that only a single iteration may be required to provide the optimization of the vibration isolators. By the term “optimized” is meant that the vibration isolators decouple steering column vibration from IP bracket vibration such that the resonance frequency of the steering column is below engine vibration frequencies when the engine is in a selected mode of operation and in a selected engine speed range (i.e., economy mode of a DoD engine in its engine speed window), and also above road travel vibration frequencies.

FIG. 9 is a graph 50 which shows how iterative adjustment/testing was able to provide the aforesaid vibration isolator optimization, whereby the steering column has a resonance frequency outside the engine vibration frequencies caused by an engine speed window of a DoD engine operating in economy mode, yet above the road travel vibration frequencies.

Test Plot 52 is for a steering column which is mounted to an IP bracket using the prior art affixment techniques without the vibration isolators of the present invention, wherein this plot is a “baseline”. It is seen that the steering column in test plot 52 has a resonance frequency R of about 37 Hz, which corresponds to an engine speed of about 1,120 RPM. However, by utilizing vibration isolators 20 according to the present invention, wherein the grommets and inserts thereof have gone through optimization, a 28 Hz resonance frequency steering column was provided, as shown by test plot 54, wherein the vibration resonance corresponds to an engine RPM well below 1,000. Test plot 54 indicates a successful optimization of the vibration isolators because the resonance frequency of the steering column is higher than road travel vibration frequencies and is below engine vibration frequencies in the full engine speed window of economy mode operation of the DoD engine, down to an engine speed of about 1,000 RPM (below 1,000 RPM the DoD engine switches to normal mode).

By comparison, another optimization test of the vibration isolators resulted in test plot 56, wherein a resonance frequency of 23 Hz was provided (which was unacceptable because the resonance frequency was lower than the vibration frequency of road travel).

Table I provides a summary of the physical parameters of the vibration isolators with respect to each of the 28 Hz test plot 52 and the 23 Hz test plot 54.

TABLE I

| Physical Parameter | 28 Hz Plot 52 | | 23 Hz Plot 54 | |
|---|---|---|---|---|
| Rubber Durometer: | 38 | | 48 | |
| First Stem Thickness: | 3 | mm | 3 | mm |
| Second Stem Thickness: | 2 | mm | 2 | mm |
| Forward Sleeve Length: | 7.13 | mm | 10.13 | mm |
| Rearward Sleeve Length: | 15.5 | mm | 17.5 | mm |
| Forward Mounting Bracket Thickness: | 5.58 | mm | 5.58 | mm |
| Rearward Mounting Bracket Thickness: | 12.45 | mm | 12.45 | mm |
| Forward Grommet Width: | 10.58 | mm | 10.58 | mm |
| Rearward Grommet Width: | 17.45 | mm | 17.45 | mm |
| Forward Grommet Compression: | 69% | | 9% | |
| Rearward Grommet Compression: | 39% | | 0% | |

In Table I, “Forward/Rearward Grommet Width” is defined as: first stem thickness plus second stem thickness plus forward/rearward mounting bracket thickness, wherein the forward/rearward mounting bracket thickness is equal to the neck length of the respective grommet. Further in Table I, “Forward/Rearward Grommet Compression” is defined as: (forward/rearward sleeve length minus forward/rearward mounting bracket thickness) divided by (first stem thickness plus second stem thickness).

Accordingly, it is seen that the vibration isolators configured and optimized according to the present invention provide a selected amount of vibration decoupling which allows for the resonance frequency of the steering column to be low enough that it is below the engine vibration frequencies of a DoD engine in economy mode across a full engine speed window of operation, yet is high enough to exceed the vibration frequencies of road travel.

To those skilled in the art to which this invention appertains, the above described preferred embodiment may be subject to change or modification. Such change or modification can be carried out without departing from the scope of the invention, which is intended to be limited only by the scope of the appended claims.

1. A vibration isolator for a steering column of a motor vehicle, comprising:
a grommet of a resilient material comprising a first stem, a second stem and a neck disposed between said first and second stems, wherein an outside diameter of each of said first and second stems exceeds an outside diameter of said neck, said grommet having a central hole passing through each of said first stem, said neck and said second stem, said grommet having a width measured inclusively between said first and second stems; and
an insert of rigid material comprising a sleeve and a washer connected to one end of said sleeve, wherein an outside diameter of said washer exceeds an outside diameter of said sleeve, said insert having an attachment hole passing through each of said washer and said sleeve, said sleeve having a length;
wherein said sleeve is received in said central hole and said washer abuts one of said first and second stems, and wherein said width and said length cooperate so as to provide a predetermined compression upon said grommet when a compressive force is applied to said grommet and said insert such that said grommet is compressed to a second width equal to said length.

2. The vibration isolator of claim 1, wherein said grommet and said insert complimentarily share a circular geometry.

3. The vibration isolator of claim 1, wherein said grommet and said insert complimentarily share an elliptical geometry.

4. A steering column and vibration isolator combination, comprising:
a steering column having a plurality of mounting brackets, wherein each of said mounting brackets has a respective mounting hole formed therein; and
a plurality of vibration isolators, one vibration isolator respectively for each said mounting bracket, each vibration isolator comprising:
a grommet of resilient material comprising a first stem, a second stem and a neck disposed between said first and second stems, wherein an outside diameter of each of said first and second stems exceeds an outside diameter of said neck, said grommet having a central hole passing through each of said first stem, said neck and said second stem, said grommet having a width measured inclusively between said first and second stems; and
an insert of rigid material comprising a sleeve and a washer connected to one end of said sleeve, wherein an outside diameter of said washer exceeds an outside diameter of said sleeve, said insert having an attachment hole passing through each of said washer and said sleeve, said sleeve having a length;
wherein the vibration isolator of each said mounting bracket is mounted respectively thereto, wherein the neck of the grommet thereof is received in the mounting hole and the first and second stems of the grommet thereof overlap the mounting hole and abut opposing sides of the mounting bracket; and
wherein for each vibration isolator, respectively, the sleeve is received in the central hole and the washer abuts one of the first and second stems, and wherein the width and the length cooperate so as to provide a predetermined compression upon the respective grommet when a compressive force is applied to the respective grommet and the respective insert such that the respective grommet is compressed to a second width equal to the length of the respective sleeve.

5. The combination of claim 4, wherein said plurality of mounting holes comprises a pair of forward mounting holes and a pair of rearward mounting holes, wherein said forward mounting holes are circular and said rearward mounting holes are elliptical; wherein said plurality of vibration isolators comprise:
a pair of forward vibration isolators which are mounted to said pair of forward mounting holes, wherein the respective grommet and insert thereof complimentarily share a circular geometry that corresponds to the circularity of said forward mounting holes; and
a pair of rearward vibration isolators which are mounted to said pair of rearward mounting holes, wherein the respective grommet and insert thereof complimentarily share an elliptical geometry that corresponds to the ellipticality of said rearward mounting holes.

6. A method for decoupling vibration of an engine with respect to a steering column of a motor vehicle by optimizing vibration isolators of the steering column so as to adjust the resonance frequency of the steering column to a frequency below a range of vibration frequencies that are generated by the engine in a selected mode of operation and within a selected range of engine speed, wherein the steering column has a plurality of mounting brackets, each mounting bracket having a mounting hole, and wherein at each mounting bracket is located a vibration isolator comprising: a grommet composed of a resilient material and comprising a first stem, a second stem and a neck disposed between the first and second stems, wherein an outside diameter of each of the first and second stems exceeds an outside diameter of the neck, wherein the grommet has a central hole passing through each of the first stem, the neck and the second stem, and wherein the grommet has a width measured inclusively between the first and second stems; and an insert composed of a rigid material and comprising a sleeve and a washer connected to one end of the sleeve, wherein an outside diameter of the washer exceeds an outside diameter of the sleeve, wherein the insert has an attachment hole passing through each of the washer and the sleeve, and wherein the sleeve has a length; wherein the vibration isolator of each mounting bracket is mounted respectively thereto, wherein the neck of the grommet thereof is received in the mounting hole and the first and second stems of the grommet thereof overlap the mounting hole and abut opposing sides of the mounting bracket; and wherein the sleeve is received in the central hole and the washer abuts one of the first and second stems; said method comprising the steps of:
determining a range of vibration produced by the engine in a selected mode of operation in a selected range of engine speed;
determining a range of vibration produced by road travel of the motor vehicle;
adjusting at least one physical parameter of each of the vibration isolators; and
measuring the resonance frequency of the steering column;
repeating said steps of adjusting and measuring until the resonance frequency of the steering column is selectively adjusted to a frequency below the range of vibration frequency produced by the engine in the selected mode of operation in the selected range of engine speed and above the range of vibration frequencies produced by road travel of the motor vehicle.

7. The method of claim 6, wherein said first step of determining comprises determining a range of vibration frequencies produced by a displacement on demand engine in economy mode.

8. The method of claim 6, wherein said step of adjusting comprises, for each vibration isolator respectively, selecting the length of said sleeve in relation to the width of the grommet such that the selected length cooperates with the width so as to provide a predetermined compression upon said grommet when a compressive force is applied to said grommet and said insert such that said grommet is compressed to a second width equal to said length.

9. The method of claim 8, wherein said first step of determining comprises determining a range of vibration frequencies produced by a displacement on demand engine in economy mode.

10. The method of claim 8, wherein said step of adjusting further comprises, for each vibration isolator respectively, selectively adjusting at least one dimension of said grommet.

11. The method of claim 10, wherein said first step of determining comprises determining a range of vibration frequencies produced by a displacement on demand engine in economy mode.

12. The method of claim 10, wherein said step of adjusting comprises, for each vibration isolator respectively, adjusting the width of the grommet.

13. The method of claim 12, wherein said step of adjusting further comprises, for each vibration isolator respectively, adjusting a thickness of at least one of said first and second stems.

14. The method of claim 13, wherein said first step of determining comprises determining a range of vibration frequencies produced by a displacement on demand engine in economy mode.

15. The method of claim 8, further comprising selectively adjusting a durometer of the grommet.

16. The method of claim 15, wherein said first step of determining comprises determining a range of vibration frequencies produced by a displacement on demand engine in economy mode.

17. The method of claim 15, wherein said step of adjusting further comprises, for each vibration isolator respectively, selectively adjusting at least one dimension of said grommet.

18. The method of claim 17, wherein said step of determining comprises determining a range of vibration frequencies produced by a displacement on demand engine in economy mode.

19. The method of claim 8, further comprising adjusting at least one of material composition of said grommet, durometer of said grommet and dimension of said grommet.

20. The method of claim 19, wherein said step of determining comprises determining a range of vibration frequencies produced by a displacement on demand engine in economy mode.
